(19) United States
(12) Patent Application Publication
(10) Pub. No.: US 2005/0239551 A1
(43) Pub. Date: Oct. 27, 2005

(54) System and method for providing interactive games

(76) Inventors: Scott Griswold, Cincinnati, OH (US); Steve Held, Cincinnati, OH (US); Kennard W. Scribner III, Carmel, IN (US)

Correspondence Address: WOODARD, EMHARDT, MORIARTY, MCNETT & HENRY LLP, BANK ONE CENTER/TOWER, 111 MONUMENT CIRCLE, SUITE 3700, INDIANAPOLIS, IN, 46204-5137, US

(21) Appl. No.: 11/112,357

(22) Filed: Apr. 22, 2005

Related U.S. Application Data
(60) Provisional application No. 60/565,484, filed on Apr. 26, 2004.

(51) Int. Cl. G06F 19/00; G06F 17/00

(52) U.S. Cl. 463/42

(57) ABSTRACT

A computer system and method that provides an interactive game that can be played by users at a live event, such as a baseball game. The user accesses the interactive game over a computer network from a client computer. Examples of client computers used to access the game include Internet-enabled cell phones, personal digital assistants, and laptops. The user is prompted to answer questions related to a prediction of some action that will occur in the live event, such as the performance of a baseball player while at bat. An administrator enters the correct answer for what actually happened, or the correct answer is otherwise determined. The system calculates a score after comparing the user's answer with the actual correct answer and provides the score to the user. Multiple users can play the game simultaneously and compete with each other, and the top scores are displayed to all users.

### CROSS-REFERENCE TO RELATED APPLICATION

This application claims the benefit of U.S. Provisional Application No. 60/565,484 filed Apr. 26, 2004, which application is incorporated herein in its entirety.

### FIELD OF THE INVENTION

This invention relates generally to interactive games, and more particularly, to an interactive game played while watching an actual event.

### BACKGROUND OF THE INVENTION

A spectator attends a sporting event at a venue to watch the event because they have an interest in the event, the team playing or at least individual players. Throughout the sporting event, however, the spectator may become disinterested at times and possibly find some other activity to observe or participate in during such periods. Venue owners recognize that interested fans typically generate more revenue than fans that are disinterested or even leave an event early.

Some spectators believe that they have enough knowledge and understanding of the sport that they could manage or coach a team. Similarly, some fans become so familiar with different players and their styles that these fans believe they can anticipate what a particular player will do, or at least should do, given a current set of circumstances during a game.

Accordingly, a need currently exists for a game that keeps the fans interested in the actual sporting event they are attending and provides them entertainment related to predicting future events that may occur during the event. The current invention is directed to meeting these and other needs.

### SUMMARY OF THE INVENTION

One form of the present invention is a unique system for providing an interactive game.

Yet another form includes unique systems and methods to provide interactive games at sporting events.

Another form includes operating a computer system that has several client computers and servers coupled together over a network. At least one client computer has a web browser that is used to communicate with a web server and access the user interface for playing the interactive game. The user plays the interactive game using the client computer during the live event. At least one server is the web server that provides access to the interactive game to the client computer. At least one server is a database server that stores at least part of the information related to the interactive game.

Another form includes a computer system and method for allowing a user to access an interactive game during a live event. The user accesses the interactive game over a global computer network, such as the Internet, from a client computer. Examples of client computers used to access the game include Internet-enabled cell phones, personal digital assistants (PDAs), and laptops, to name a few non-limiting examples. The user is prompted to answer a series of questions that are related to a prediction of some particular action that will occur in the live event. A non-limiting example of a particular action is the performance of a particular baseball player while at bat. After each particular action occurs, an administrator enters the correct answer for what actually happened, or the correct answer is otherwise determined. The system then calculates a score for the user after comparing the user's answer with the actual correct answer. The user's score is displayed to the user on the client computer. Multiple users can play the game simultaneously and compete with each other. The top scores are displayed to all users so they can see who have the highest scores.

Another form includes a computer system and method for providing an interactive game to users who are spectators attending a live baseball game. The user enters a prediction onto a client computer, such as an Internet-enabled PDA or cell phone, of what will occur next in the actual baseball game. A few non-limiting examples of such predictions include predicting what a batter will do while at bat or what a pitcher will throw given the current game conditions. An administrator of the interactive game then enters the actual result of each applicable play that actually happens during the game, or the actual result is otherwise received by the system programmatically. The system then calculates a score for the user based on how closely the user's prediction matches the actual result that was entered by the administrator or programmatically. Before leaving the event venue, the user is able to see how well they performed in the interactive game. In addition, a number of users can compete against each other to see who wins the interactive game.

Yet other forms, embodiments, objects, advantages, benefits, features, and aspects of the present invention will become apparent from the detailed description and drawings contained herein.

### BRIEF DESCRIPTION OF THE DRAWINGS

FIG. 1 is a diagrammatic view of a computer system of one embodiment of the present invention.

FIGS. 2A-2B are a high-level process flow diagram for the system of FIG. 1.

FIG. 3 is a process flow diagram for the system of FIG. 1 demonstrating the stages performed by an adminstrator of the interactive game.

FIG. 4 is a process flow diagram for the system of FIG. 1 demonstrating the stages performed by a user of the interactive game.

FIGS. 5A-5B are a process flow diagram for the system of FIG. 1 demonstrating the stages involved in using the system with a live baseball game.

FIG. 6 is a simulated screen of one embodiment of the system of FIG. 1 showing how an adminstrator views/manages the player lineup for a particular game.

FIG. 7 is a simulated screen of one embodiment of the system of FIG. 1 showing how an adminstrator specifies the current player that is at bat.

FIG. 8 is a simulated screen of one embodiment of the system of FIG. 1 showing an example of how a user logs in to the interactive game.

FIG. 9 is a simulated screen of one embodiment of the system of FIG. 1 showing a welcome screen that welcomes the user to the interactive game.

FIG. 10 is a simulated screen of one embodiment of the system of FIG. 1 showing a prediction question presented to the user.

FIG. 11 is a simulated screen of one embodiment of the system of FIG. 1 showing a wait screen while the user is waiting for the results of the player's at bat.

FIG. 12 is a simulated screen of one embodiment of the system of FIG. 1 showing how an administrator locks out a question so no more answers can be given.

FIG. 13 is a simulated screen of one embodiment of the system of FIG. 1 showing how an administrator inputs the actual outcome of the action during the live event.

FIG. 14 is a simulated screen of one embodiment of the system of FIG. 1 showing the user's individual performance on the question which was answered correctly.

FIG. 15 is a simulated screen of one embodiment of the system of FIG. 1 showing the user's individual performance on the question which was answered incorrectly.

FIG. 16 is a simulated screen of one embodiment of the system of FIG. 1 showing the users with the top scores.

### DETAILED DESCRIPTION

For the purposes of promoting an understanding of the principles of the invention, reference will now be made to the embodiments illustrated in the drawings and specific language will be used to describe the same. It will nevertheless be understood that no limitation of the scope of the invention is thereby intended. Any alterations and further modifications in the described embodiments, and any further applications of the principles of the invention as described herein are contemplated as would normally occur to one skilled in the art to which the invention relates.

One embodiment of the present invention includes a unique system for providing an interactive game to be played by users during a live event, such as spectators attending the live event. The user accesses the interactive game over a global computer network, such as the Internet, from a client computer or computer-type devices (collectively referred to as “computer”). Examples of client computers used to access the game include cell phones, personal digital assistants (PDAs), laptops, desktops, and any and all game devices such as PS2, Xbox, Nintendo and other similar devices to log onto a game service datacenter or web site, to name a few non-limiting examples. The users can play the game in a stadium, ball park, arena, coliseum, sporting event venue, civic event venue, or any and all places that provide access to the network. As the live event progresses, the user is prompted to answer questions that are related to a prediction of some particular action that will occur in the live event. A non-limiting example of a particular action is the performance of a particular baseball player while at bat. After each particular action occurs, an administrator enters the correct answer for what actually happened, or the correct answer is otherwise determined. The system then calculates a score for the user after comparing the user's answer with the actual correct answer. The user's score is displayed to the user on the client computer. Multiple users can play the game simultaneously and compete with each other. The top scores are displayed to all users so they can see who have the highest scores.

The interactive game may be played individually by a potentially unlimited number of users in conjunction with an on-going competitive athletic or other type of event by contestants having a high level of skill and knowledge as well as contestants without such skill and knowledge. The game can be played using a variety of computer devices that include devices which the user already owns or which the user can rent at the ball park or other retail outlet. In accordance with one aspect of the present invention, a number of wireless computer devices are available for distribution to contestants. The devices may be distributed to spectators at sporting events, to patrons of a store, to subscribers as part of an advertiser's promotional campaign, or any similar method of distribution. These wireless devices may also be made available for sale (or given away) at establishments that typically sell or provide electronic devices such as PDAs, cell phones, laptops or other devices. No particular brand or type of computer, or particular operating system, is required in order access the interactive game, other than a client computer that has a network connection and is capable of communicating properly with a particular server (such as a web server) to access and display the game.

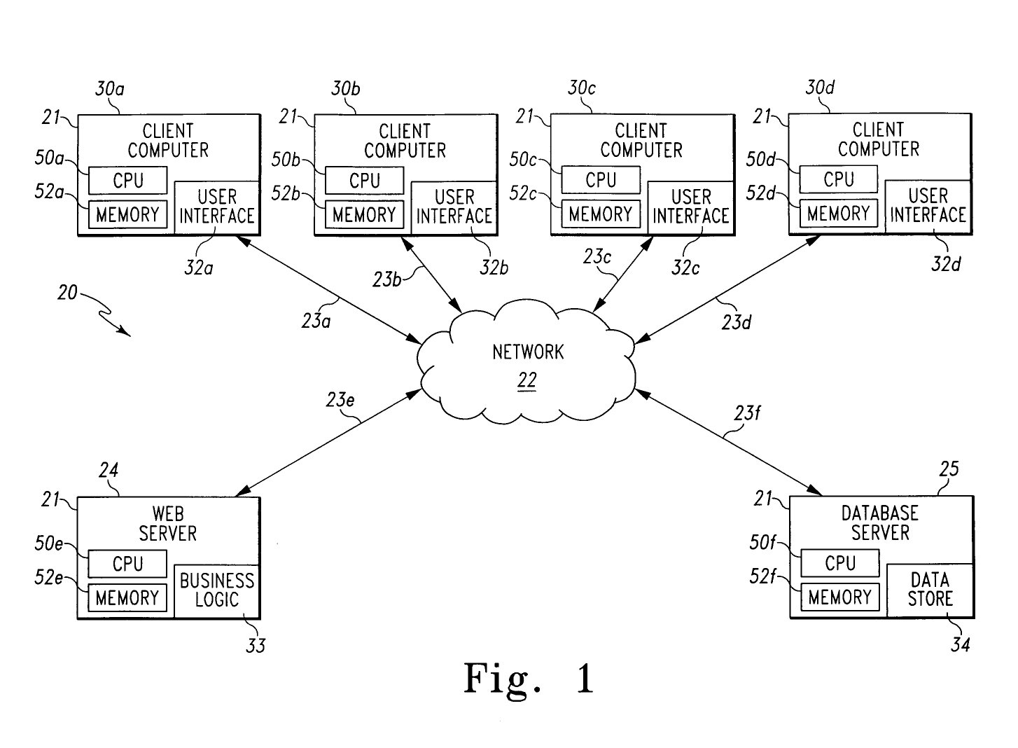

FIG. 1 is a diagrammatic view of computer system 20 of one embodiment of the present invention. Computer system 20 includes computer network 22. Computer network 22 couples together a number of computers 21 over network pathways 23a-f. More specifically, system 20 includes several servers, namely Web Server 24 and Database Server 25. System 20 also includes client computers 30a, 30b, 30c, and 30d (collectively 30). While computers 21 are each illustrated as being a server or client, it should be understood that any of computers 21 may be arranged to include both a client and server. Furthermore, it should be understood that while six computers 21 are illustrated, more or fewer may be utilized in alternative embodiments.

Computers 21 include one or more processors or CPUs (50a, 50b, 50c, 50d, 50e, and 50f, respectively) and one or more types of memory (52a, 52b, 52c, 52d, 52e, and 52f, respectively). Each memory 52a, 52b, 52c, 52d, 52e, and 52f preferably includes a removable memory device. Each processor 50a-50f may be comprised of one or more components configured as a single unit. Alternatively, when of a multi-component form, a processor 50a-50f may have one or more components located remotely relative to the others. One or more components of each processor 50a-50f may be of the electronic variety defining digital circuitry, analog circuitry, or both. In one embodiment, each processor 50a-50f is of a conventional, integrated circuit microprocessor arrangement, such as one or more PENTIUM III or PENTIUM 4 processors supplied by INTEL Corporation of 2200 Mission College Boulevard, Santa Clara, Calif. 95052, USA.

Each memory 52a-52f (removable or generic) is one form of a computer-readable device. Each memory may include one or more types of solid-state electronic memory, magnetic memory, or optical memory, just to name a few. By way of non-limiting example, each memory may include solid-state electronic Random Access Memory (RAM), Sequentially Accessible Memory (SAM) (such as the First-In, First-Out (FIFO) variety or the Last-In-First-Out (LIFO) variety), Programmable Read Only Memory (PROM), Electronically Programmable Read Only Memory (EPROM), or Electrically Erasable Programmable Read Only Memory (EEPROM); an optical disc memory (such as a DVD or CD ROM); a magnetically encoded hard disc, floppy disc, tape, or cartridge media; or a combination of any of these memory types. Also, each memory may be volatile, nonvolatile, or a hybrid combination of volatile and nonvolatile varieties.

Although not shown to preserve clarity, in one embodiment each computer 21 is coupled to a display and/or includes an integrated display. Computers 21 may be of the same type, or a heterogeneous combination of different computing devices. Likewise, displays may be of the same type, or a heterogeneous combination of different visual devices. Although again not shown to preserve clarity, each computer 21 may also include one or more operator input devices such as a keyboard, mouse, track ball, light pen, and/or microtelecommunicator, to name just a few representative examples. Also, besides a display, one or more other output devices may be included such as a loudspeaker or printer. Various display and input device arrangements are possible.

Computer network 22 can be in the form of a wireless or wired Local Area Network (LAN), Municipal Area Network (MAN), Wide Area Network (WAN), such as the Internet, a combination of these, or such other network arrangement as would occur to those skilled in the art. The operating logic of system 20 can be embodied in signals transmitted over network 22, in programming instructions, dedicated hardware, or a combination of these. It should be understood that more or fewer computers 21 can be coupled together by computer network 22.

In one embodiment, system 20 operates at one or more physical locations where Web Server 24 is configured as a web server that hosts application business logic 33 for an interactive game web site, Database Server 25 is configured as a database server for storing relational and other data 34 for the interactive game web site, at least one of client computers 30a-30d are configured for providing a user interface 32a-32d, respectively, for accessing the interactive game web site, and at least one of client computers 30a-30d are configured for providing one or more administrators with access to the interactive game settings. User interface 32a-32d of client computers 30a-30d can be browser-based, can be an installable application such as one that communicates with web server 34, can be a thick or smart client, and/or can be embedded software, to name a few non-limiting examples. In one embodiment, web server 24 provides HTML pages, data from web services (such as those based on the SOAP protocol), and/or other Internet standard or company proprietary data formats to one or more or client computers 30a-30d when requested. One of ordinary skill in the art will recognize that the term web server 24 is used generically for purposes of illustration and is not meant to imply that network 22 is required to be the Internet. As described previously, network 22 can be one of various types of networks as would occur to one of ordinary skill in the art. Database (data store) 34 on Database Server 25 can store data such as scores and data about games being played, historical data about past games, statistics about the athletes, data about the actual sporting event, advertisements to send to client computers 30, and/or video clips or other entertainment to send to the client computers 30. Typical applications of system 20 would include more or fewer client computers 30a-30d of this type at one or more physical locations, but four have been illustrated in FIG. 1 to preserve clarity. Furthermore, although two servers 24 and 25 are shown, it will be appreciated by those of ordinary skill in the art that the one or more features provided by Web Server 24 and Database Server 25 could be provided by the same computer or varying other arrangements of computers at one or more physical locations and still be within the spirit of the invention. Farms of dedicated servers could also be provided to support the specific features if desired.

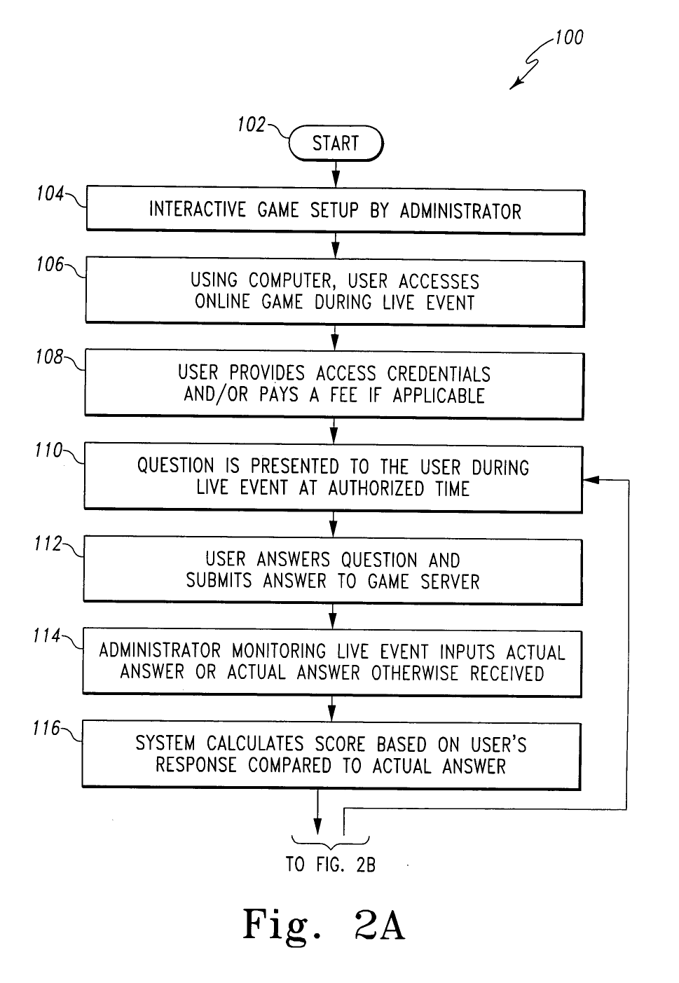

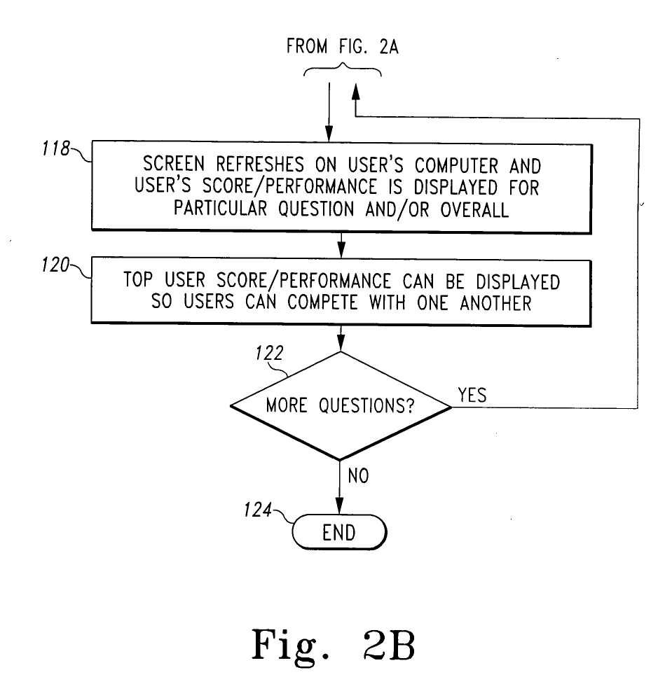

Referring also to FIGS. 2A-2B, one embodiment for implementing system 20 is illustrated in flow chart form as procedure 100, which demonstrates one form of a high-level process for the system of FIG. 1 and will be discussed in more detail below. In one form, procedure 100 is at least partially implemented in the operating logic of system 20. Procedure 100 begins on FIG. 2A at start point 102 with an administrator setting up an interactive game (stage 104). Using one of client computers 30a-30d, which may be a portable computer, for example, the user accesses the online game during the live event (stage 106). In one embodiment, the live event can include a baseball game, a basketball game, a football game, other type of sporting event, beauty pageant, or other civic event, to name a few non-limiting examples. In one embodiment, the user must provide access credentials and/or pay a fee before accessing the interactive game (stage 108), such as registering as members of a gaming service before being provided with access to the game. In other embodiments, no access credentials or fee are required. A prediction question is presented to the user during the live event at an authorized time (stage 110). Regardless of how the authorized time-window is actually calculated, a lock-out signal is implemented that prevents users from entering a late answer, e.g., prediction. According to one embodiment of the present invention, the user's computer displays the amount of time that remains to enter a prediction.

The user answers the prediction question and submits the answer to the game web server 24 (stage 112). Additionally, the user's computer may display a confirmation icon or some similar indicator that provides the user with confirmation that their prediction was properly entered and received and acknowledged by the web server 24. If no prediction is received from a user, web server 24 may be configured to use the user's previous prediction as a default prediction, or web server 24 may be configured to use no prediction at all such that the user is guaranteed to receive zero points. Some embodiments of the present invention allow only one prediction to be selected. Other embodiments may permit a user to change the selected prediction, such as between pitches. Alternatively or additionally, web server 24 may provide historical hints or other information to help in the prediction process.

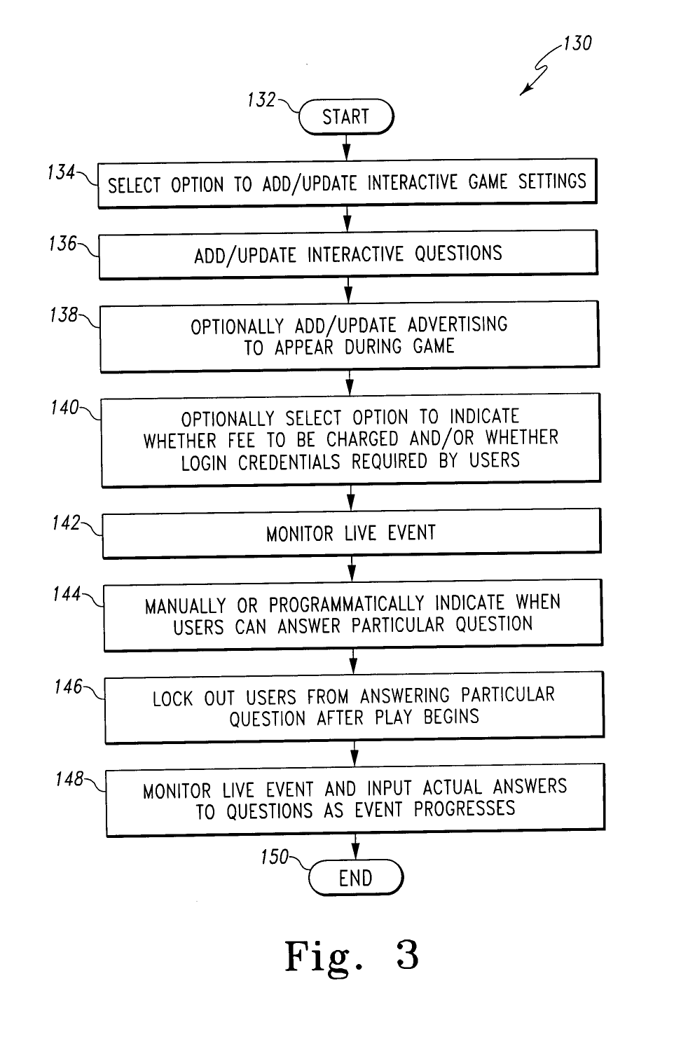

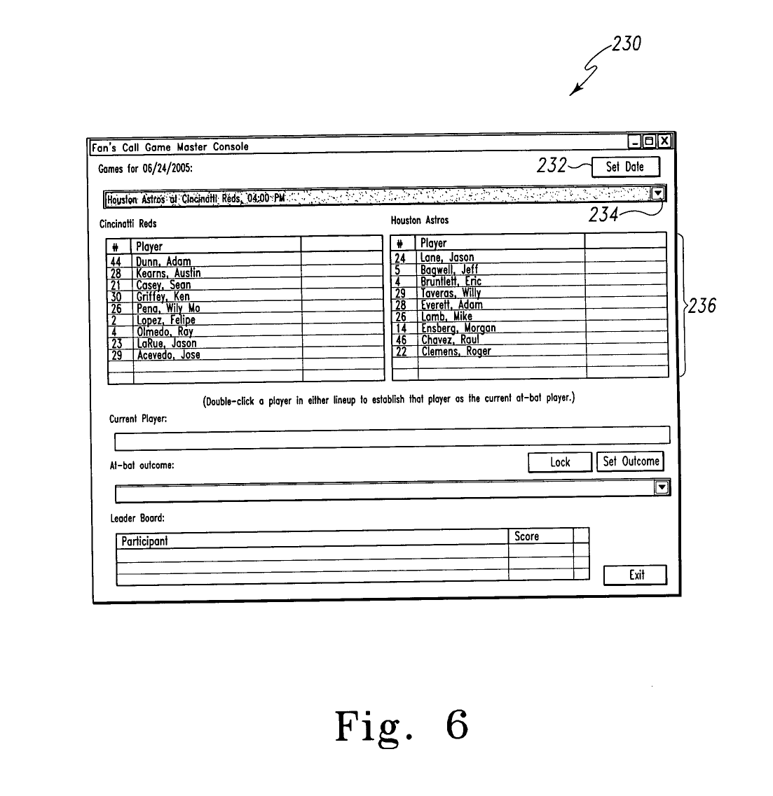

The administrator monitoring the live event inputs the actual answer (correct answer) or the actual answer is otherwise received (stage 114). The system calculates a score based on the user's response compared to the actual answer (stage 116). Each question has a point value associated with it. In one embodiment, the assigned values reflect the probability that an event will occur such that predicting less-probable events results in receiving a higher score. Alternatively or additionally, accelerated scoring can be implemented at different times during the game (e.g., score values increase during the later innings). For example, in the case of a baseball game, one example of accelerated scoring might be to double the scores after the third inning and triple after the sixth inning. Turning now to FIG. 2B, the screen refreshes on the user's computer and the user's score/performance is displayed for the particular question and/or overall (stage 118). A user's score may be updated nearly instantaneously after the event occurs in the actual game or results may be aggregated such that the score is not updated until the end of some particular time period, such as each half inning. The top user scores/performance can be displayed so users can compete with one another (stage 120). In one embodiment, the leading interactive scores are displayed on the scoreboard or other display of the venue itself. For each of the questions in the interactive game, the stages 110 through 120 are repeated. These stages will now be described in further detail in reference to FIGS. 3-5 and in the simulated screens of FIGS. 6-16.

Referring now to FIG. 3, procedure 130 demonstrates one form of the more detailed stages of system 20 which involve the actions performed by one or more administrators managing the interactive game. In one form, procedure 130 is at least partially implemented in the operating logic of system 20. Procedure 130 begins at start point 132 with the administrator using one of computers 30a-30d to select an option to add/update the interactive game settings (stage 134). The administrator can add and/or update the interactive questions that will be provided to the users during the actual game (stage 136). In one embodiment, the administrator adds and/or updates all of the interactive questions before the live event begins. In another embodiment, the administrator adds and/or updates some or all of the questions during the live event based on one or more occurrences in the live event. The administrator can optionally add and/or update advertising that is to be displayed to the users during the actual game (stage 138). The administrator can optionally select an option to indicate whether the user must pay a fee and/or specify login credentials before accessing the game (stage 140). In one embodiment, the same or a different administrator then monitors the live event (stage 142). This person can be a contractor or employee of the game provider, a third-part statistics provider (e.g., STATS, Inc.), or may be an employee or contractor of the venue. The administrator manually indicates when users are presented with and can answer a particular prediction question, or the system programatically determines when the questions can be answered (stage 144). The administrator selects an option to lock out users from answering a particular prediction question once the particular action/play to be predicted has begun (stage 146). The administrator continues to monitor the live event and inputs actual (correct) answers to the prediction questions as the event progresses (stage 148). The process then ends at end point 150.

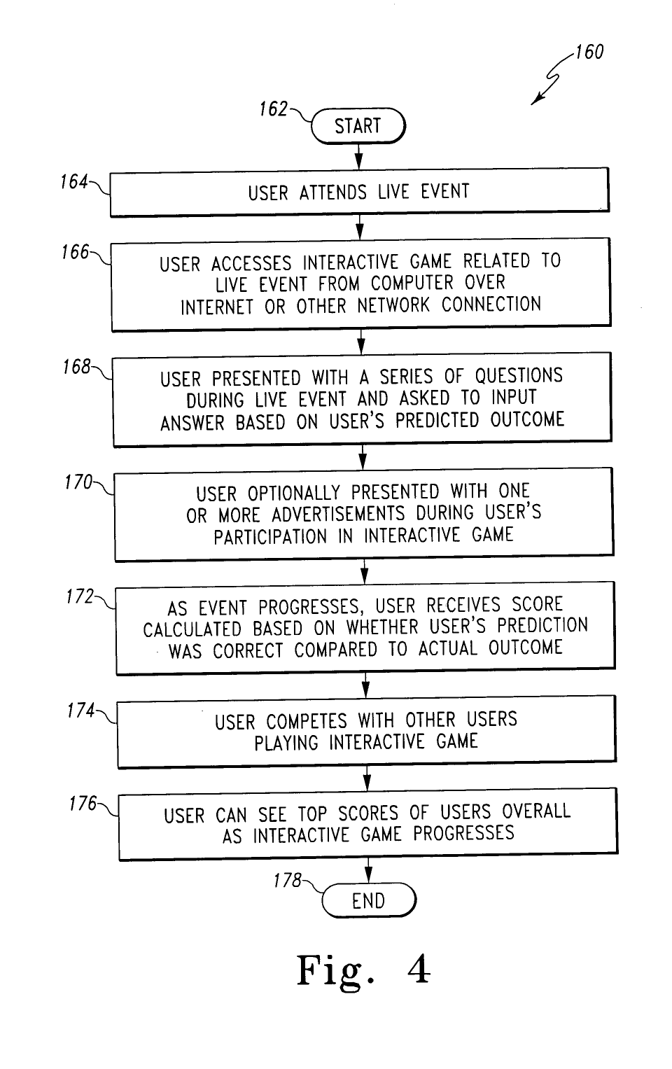

Referring now to FIG. 4, procedure 160 demonstrates one form of one of the detailed stages of system 20 which involve the actions performed by a user participating in the interactive game. In one form, procedure 160 is at least partially implemented in the operating logic of system 20. Procedure 160 begins at start point 162 with the user attending the live event (stage 164). In another embodiment, the user watches the live event at a remote location, such as on television. The user accesses the interactive game related to the live event from one of client computers 30a-30d over a network 22 such as the Internet (stage 166). The user is presented with a series of questions during the live event and asked to input an answer based on the user's prediction of the actual outcome for each particular action/play (stage 168). In one embodiment, the user is presented with one or more advertisements during the user's participation in the game (stage 170). The advertisements can be paid advertisements or free advertisements, such as sponsor advertisements. As the live event progresses, the user receives a score that is calculated based on whether the user's one or more predictions are correct compared to the actual outcome (stage 172). In one embodiment, the user's score for a particular question is provided along with the user's overall cumulative score. Other scoring variations are also possible. The user can compete with other users playing the interactive game at the same time (stage 174). The user can see top scores of users overall as the interactive game progresses (stage 176). The process then ends at end point 178.

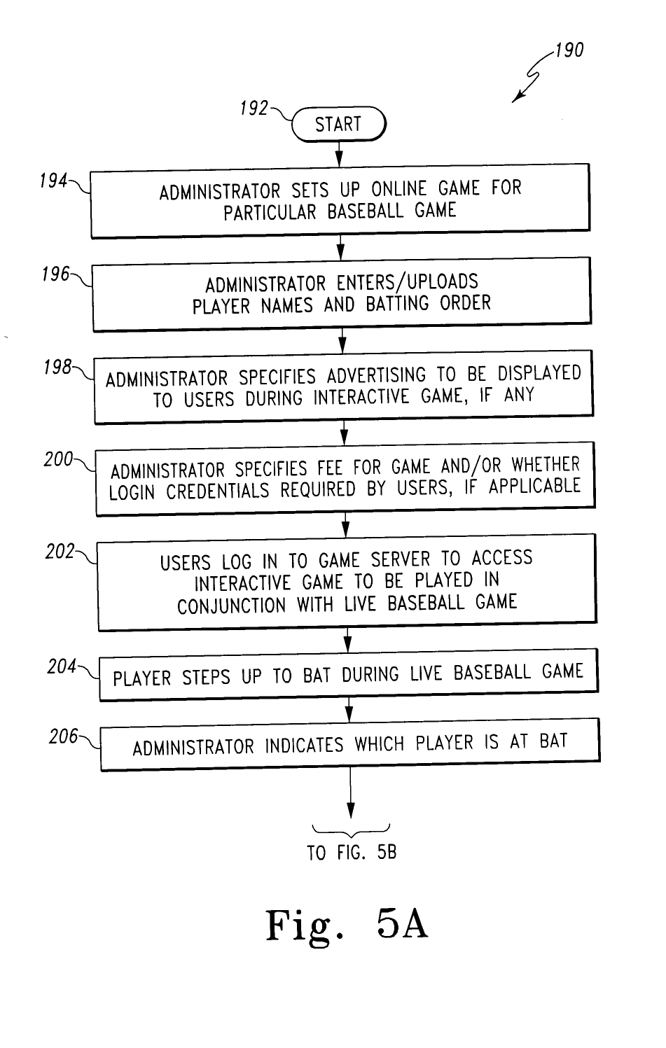

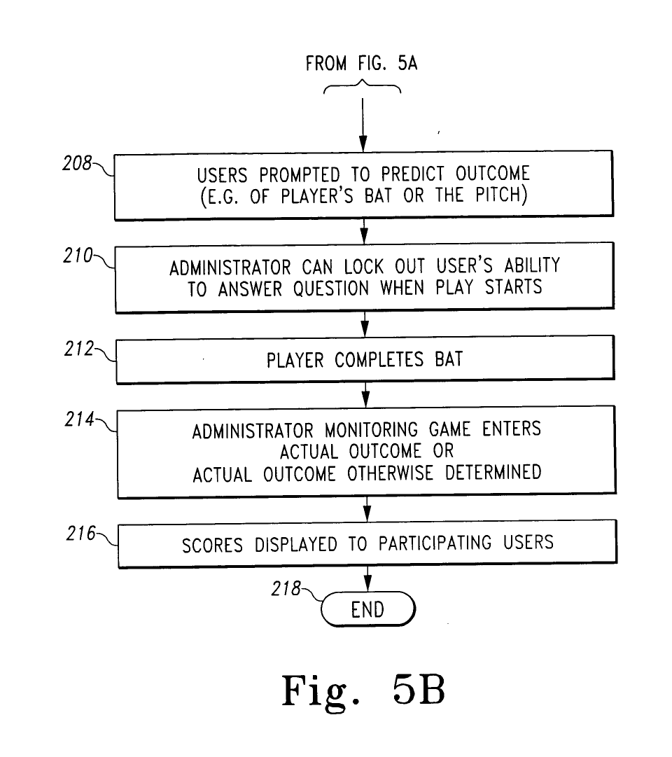

Referring now to FIGS. 5A-5B, procedure 190 demonstrates one form of another of the detailed stages of system 20 to provide an interactive game that is based on a live baseball event. In one form, procedure 190 is at least partially implemented in the operating logic of system 20. Procedure 190 begins at start point 192 on FIG. 5A with the administrator using one of computers 30a-30d to set up the online game for a particular baseball game (stage 194). The administrator enters and/or uploads the player names and batting order for the game and other applicable details (stage 196). The administrator also specifies if any advertising is to be displayed to the users during the interactive game (stage 198). The administrator also specifies whether a fee is to be charged to users for their access to the game and/or whether the user must provide login credentials to access the game (stage 200).

The users login to the game web server 24 to access the interactive game during the live baseball game, such as by providing a first and last name, or a user name and a password, if required (stage 202). When a baseball player steps up to bat during the live baseball game (stage 204), the administrator selects an option to indicate which player is at bat (stage 206). Turning now to FIG. 5B, the participating users are prompted to predict the outcome of the play (e.g. of the player's bat or the pitch itself) (stage 208). Non-limiting examples of possible outcomes of the play include home run, double play, ground out, sacrifice, single, double, strike out, fly out, walk, fielder's choice, triple, triple play, hit by pitch, etc. The administrator can lock out the users' ability to answer the question once the play starts (stage 210). The player completes the at bat or pitch (stage 212). The administrator monitoring the game enters the actual outcome or the actual outcome is otherwise determined (stage 214). The scores are displayed to all participating users to indicate how they performed on the question (stage 216).

Throughout the interactive game, other information can be displayed to the user upon demand or without being requested, such as advertisements. In the particular environment of a baseball game, examples of the type of information that can be displayed to the user includes, but is not limited to, the nine positions on the baseball diamond, team rosters, different possible event options, the user's current score, the current information about the actual baseball game (e.g., inning, outs, score, pitch count, etc.), and a display of scores of other users that are current leaders of the interactive game. The process then ends at end point 218.

A simulated example will now be described with reference to FIGS. 6-16 to illustrate the stages of FIGS. 2-5 in further detail. One will appreciate that the interactive game details and stages followed in this example are illustrative only and are not intended to be limiting in nature. For the sake of simplicity, specific reference will be made only to the baseball stages illustrated in FIGS. 5A-5B, but this example also further illustrate the corresponding stages described in FIGS. 2-4 as well. Turning now to FIG. 6, a simulated screen 230 is shown that illustrates an administrator setting up the details for a particular baseball game (stage 194). The administrator can use screen 230 to manage the interactive game details, such as player names and batting order (stage 196). Upon selecting a date for the game via selection button 232, and then selecting a particular game on that date via selector 234, the details of the teams and players for that game are displayed in tables 236.

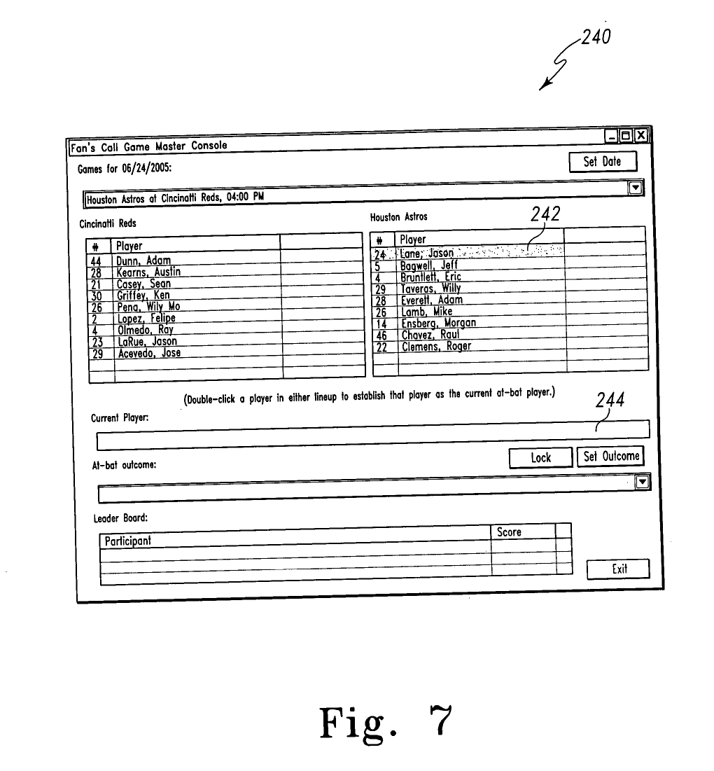

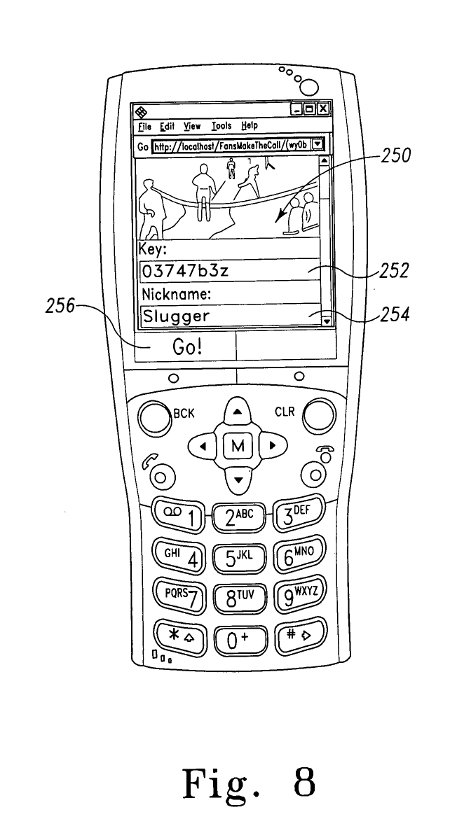

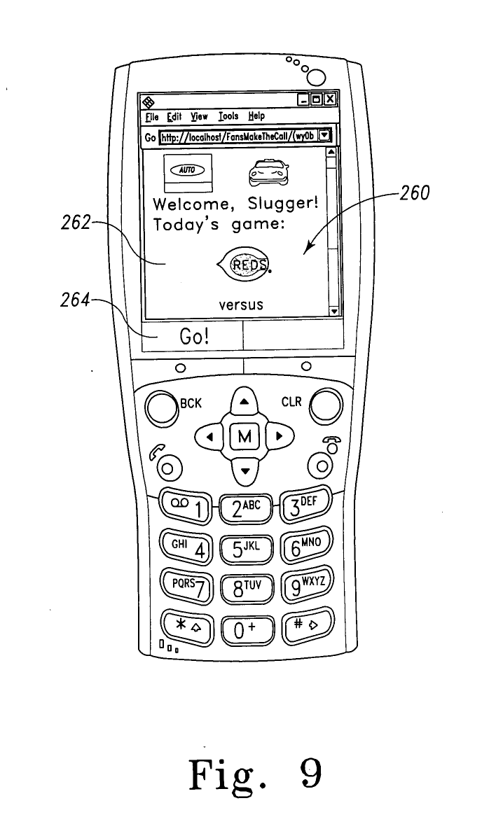

Turning now to FIG. 7, a simulated screen 240 is shown that illustrates how an administrator indicates which question should be displayed to the users, which in this baseball example is based on what player is at bat (stage 206). The administrator selects the current player that is at bat from table 242, and that player is displayed as the current player on display line 244. As shown in the simulated screen in FIG. 8, at some point, preferably before the first play of the game begins, the user accessing the game is prompted to enter login information, such as by entering a key or password 252 and a nickname 254, and then proceeding by selecting the go option 256 (stage 202). After logging in to the interactive game, the user may see a welcome message 262 similar to that shown on simulated screen 260 of FIG. 9, which allows the user to press go button 264 in order to receive the first authorized question at an authorized time.

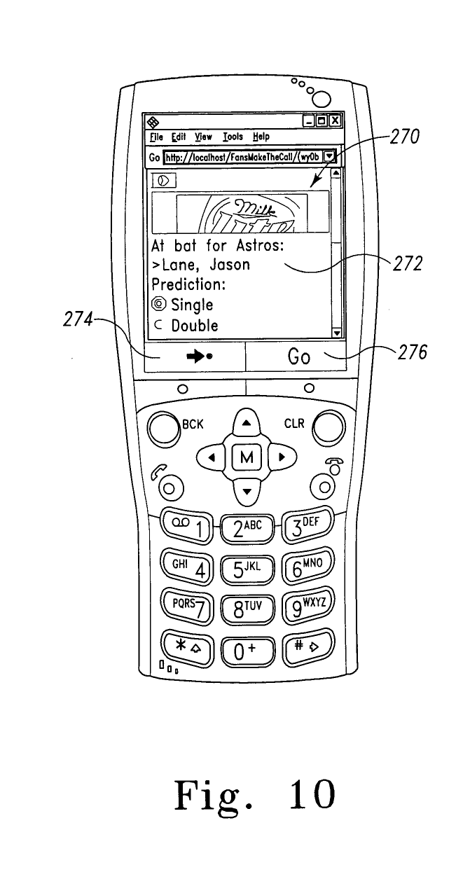

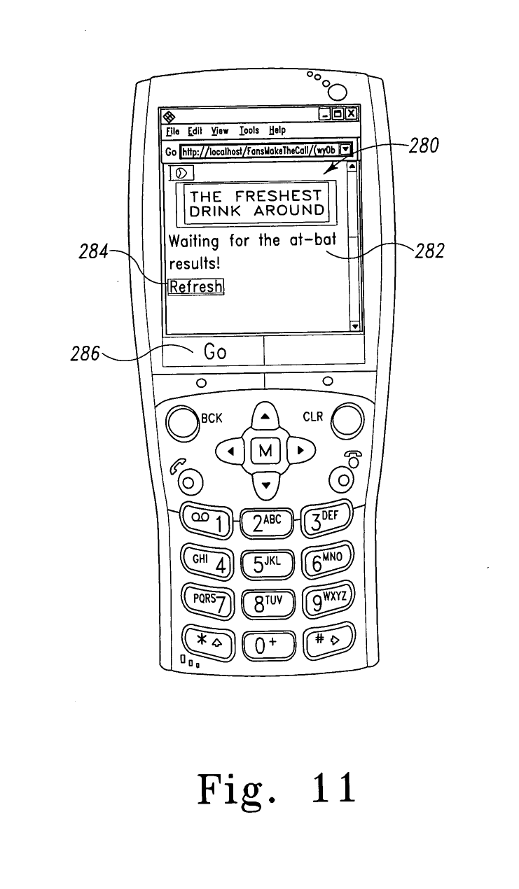

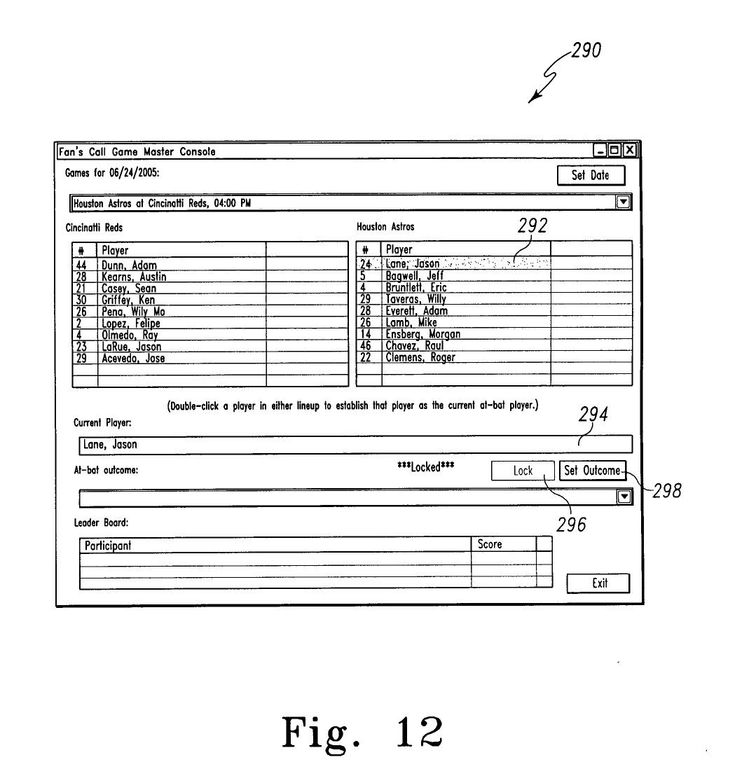

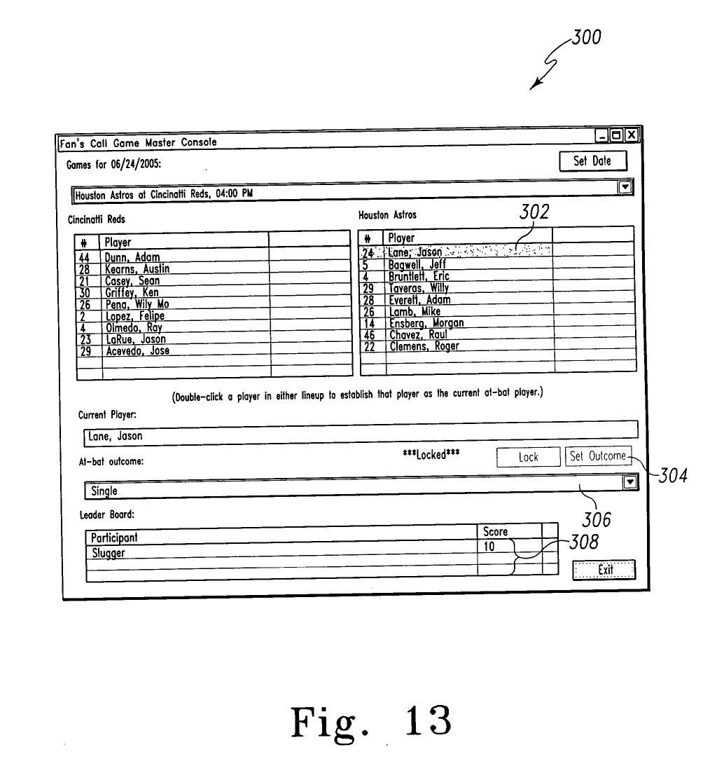

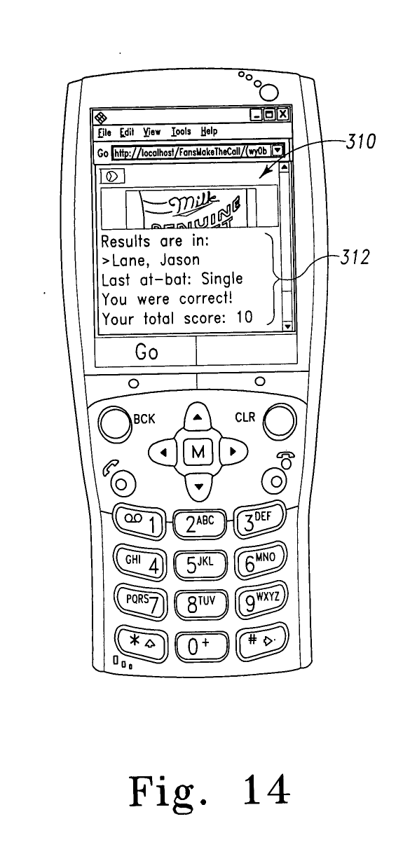

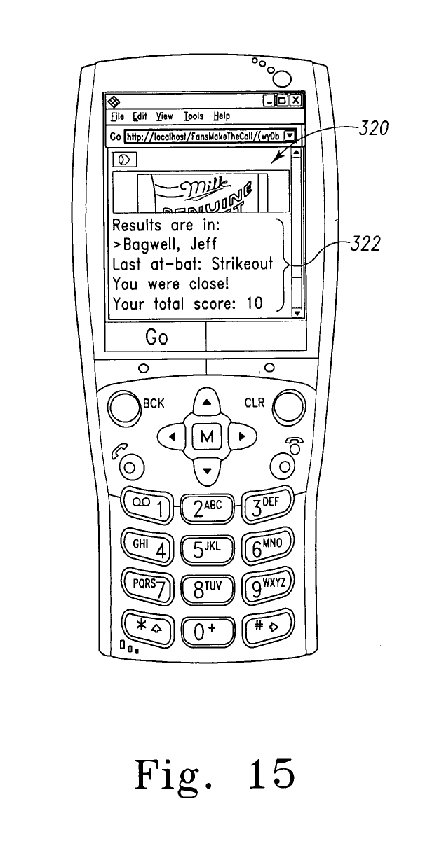

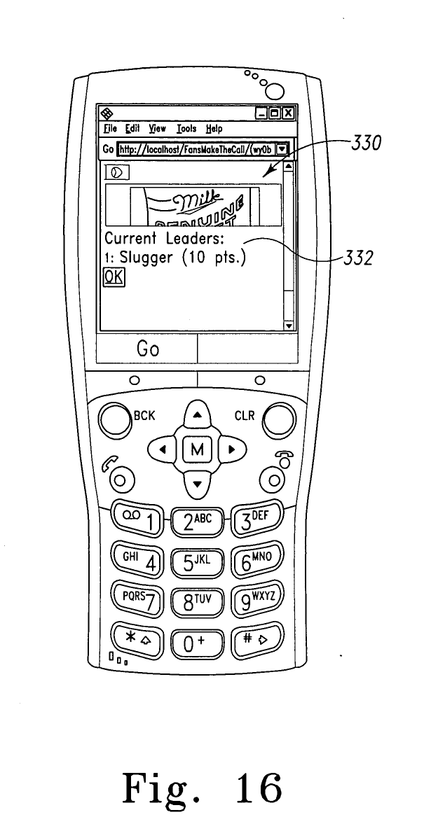

As shown in the simulated screen 270 of FIG. 10, after the administrator has authorized a particular question to be answered, the user sees the question 272, is able to select a desired answer via selector button 274, and submits the answer by selecting the go option 276 (stage 208). As shown in FIG. 11, the simulated screen 280 indicates via message 282 that the actual results are not yet available for the player at bat. As shown in FIG. 12, the administrator can use simulated screen 290 to lock out the users' ability to answer the question at this point since the play has already started (stage 210). To lock the question, the administrator selects a particular player from table 292, confirms that the selected player is displayed as the current player on display line 294, and then selects the Lock option 296. The player then completes the bat (stage 212), and the administrator activates the Set Outcome option by pressing button 298 to specify what actually happened during the play. Turning now to FIG. 13, simulated screen 300 illustrates that after selecting the Set Outcome option 304, the administrator can select the result of the play from display line 306 (stage 214), which in this example was a single. The administrator can see the top user scores on table 308 for the game so far. Returning to FIG. 11, the user can select a refresh option 284 and select the go option 286 in order to refresh the screen now that the actual play has completed. A scoring screen similar to FIG. 14 or FIG. 15 is then displayed (stage 216). Screen 310 of FIG. 14 indicates an example message 312 of what a user who answered correctly might see. On the other hand, screen 320 on FIG. 15 indicates an example message 322 of what a user who answered incorrectly might see. FIG. 16 is a simulated screen 330 which illustrates an example message 332 showing the users who have the current top scores for the interactive game. The process then ends (stage 218).

In one embodiment of the present invention, a method is disclosed that comprises: receiving a request from a user to access an interactive game to be played in conjunction with a live event, said request being originated from a computer of the user and transmitted over a network; providing to the computer a question to be answered by the user, said question being related to a prediction of an outcome of a particular activity in the live event; receiving an answer to the question from the user, said answer being submitted by the user from the computer before the particular action occurs in the live event; receiving a correct answer after the particular action occurs in the live event; calculating a score for the user based on a comparison of the answer from the user to the correct answer; and providing the score to the computer.

In another embodiment of the present invention, a system is disclosed that comprises: at least one client computer; a server computer, said server computer being coupled to the at least one client computer over a network; and said server computer being operable to receive a request from the client computer to access an interactive game to be played in conjunction with a live event, to provide to the client computer a plurality of questions that are related to a prediction of an outcome for each of a plurality of particular actions in the live event, to receive an answer from the client computer for each of the questions, to receive a correct answer for each of the questions after each of the plurality of particular actions in the live event occur, to calculate a score based at least in part on a comparison of each answer received from the client computer with the correct answer of each question, and to provide the score to the client computer on at least one occasion.

In yet another embodiment of the present invention, an apparatus is disclosed that comprises: a device encoded with logic executable by one or more processors to: receive a request from a user to access an interactive game to be played in conjunction with a live event, said request being originated from a computer of the user and transmitted over a network; provide to the computer a question to be answered by the user, said question being related to a prediction of an outcome of a particular activity in the live event; receive an answer to the question from the user, said answer being submitted by the user from the computer before the particular action occurs in the live event; receive a correct answer after the particular action occurs in the live event; calculate a score for the user based on a comparison of the answer from the user to the correct answer; and provide the score to the computer.

A person of ordinary skill in the computer software art will recognize that the client and/or server arrangements, user interface screen content, and data layouts could be organized differently to include fewer or additional options or features than as portrayed in the illustrations and still be within the spirit of the invention.

While the invention has been illustrated and described in detail in the foregoing description, the same is to be considered as illustrative and not restrictive in character, it being understood that only the preferred embodiments have been described and that all changes and modifications that come within the spirit of the invention are desired to be protected.

1. A method comprising:
receiving a request from a user to access an interactive game to be played in conjunction with a live event, said request being originated from a computer of the user and transmitted over a network;
providing to the computer a question to be answered by the user, said question being related to a prediction of an outcome of a particular activity in the live event;
receiving an answer to the question from the user, said answer being submitted by the user from the computer before the particular action occurs in the live event;
receiving a correct answer after the particular action occurs in the live event;
calculating a score for the user based on a comparison of the answer from the user to the correct answer; and
providing the score to the computer.

2. The method of claim 1, wherein said network is the Internet.

3. The method of claim 1, wherein said computer is an Internet-enabled cell phone.

4. The method of claim 1, wherein said computer is an Internet-enabled personal digital assistant.

5. The method of claim 1, wherein said computer is an Internet-enabled laptop.

6. The method of claim 1, wherein said correct answer is received from an administrator of the interactive game who is monitoring the live event.

7. The method of claim 1, wherein the steps are performed simultaneously for a plurality of users playing the interactive game in conjunction with the live event.

8. The method of claim 7, wherein a list of top scorers is provided to each of the plurality of users after each question so the users can compete with each other.

9. The method of claim 1, further comprising:
repeating said providing a question, receiving an answer from the user, receiving a correct answer, calculating the score, and providing the score steps for a plurality of particular actions in the live event.

10. The method of claim 1, wherein an administrator controls a timing of when the user can answer the question.

11. The method of claim 1, wherein an access credential must be received from the user before the user is able to participate in the interactive game.

12. The method of claim 1, wherein a fee must be received from the user before the user is able to participate in the interactive game.

13. The method of claim 1, wherein the live event is a baseball game and wherein the particular action that the question is based upon is a performance of a particular baseball player in the live event.

14. The method of claim 1, wherein said particular baseball player is at bat in the live event.

15. The method of claim 1, wherein said particular baseball player is pitching in the live event.

16. The method of claim 1, wherein the live event is a baseball game and wherein the particular action that the question is based upon is a type of a pitch from a baseball pitcher to a particular baseball player at the bat in the live event.

17. A system comprising:
at least one client computer;
a server computer, said server computer being coupled to the at least one client computer over a network; and
said server computer being operable to receive a request from the client computer to access an interactive game to be played in conjunction with a live event, to provide to the client computer a plurality of questions that are related to a prediction of an outcome for each of a plurality of particular actions in the live event, to receive an answer from the client computer for each of the questions, to receive a correct answer for each of the questions after each of the plurality of particular actions in the live event occur, to calculate a score based at least in part on a comparison of each answer received from the client computer with the correct answer of each question, and to provide the score to the client computer on at least one occasion.

18. The system of claim 17, wherein at least a portion of the request received from the client computer is a call to a web service on the server computer.

19. The system of claim 17, wherein the server computer is further operable to communicate with a plurality of client computers simultaneously over the network to allow the plurality of client computers to access the interactive game.

20. The system of claim 17, wherein the network is the Internet.

21. The system of claim 17, wherein the at least one client computer is a personal digital assistant.

22. The system of claim 17, wherein the at least one client computer is a cell phone.

23. The system of claim 17, wherein the at least one client computer is a laptop.

24. The system of claim 17, wherein the at least one client computer is a desktop.

25. An apparatus comprising: a device encoded with logic executable by one or more processors to:
receive a request from a user to access an interactive game to be played in conjunction with a live event, said request being originated from a computer of the user and transmitted over a network;
provide to the computer a question to be answered by the user, said question being related to a prediction of an outcome of a particular activity in the live event;
receive an answer to the question from the user, said answer being submitted by the user from the computer before the particular action occurs in the live event;
receive a correct answer after the particular action occurs in the live event;
calculate a score for the user based on a comparison of the answer from the user to the correct answer; and
provide the score to the computer.

26. The apparatus of claim 25, wherein the device includes a removable memory device carrying a number of processor executable instructions to define the logic.

27. The apparatus of claim 26, wherein the removable memory device includes a disk.
